(19) United States
(12) Patent Application Publication
(10) Pub. No.: US 2010/0187855 A1
(43) Pub. Date: Jul. 29, 2010

(54) Door trim

(75) Inventors: Takahiro Kitajima, Shizuoka-ken (JP); Shuji Inui, Aichi-ken (JP); Hikaru Ando, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/457,005

(22) Filed: May 28, 2009

(30) Foreign Application Priority Data
May 30, 2008 (JP) 2008-142137

(51) Int. Cl. B60R 13/02

(52) U.S. Cl. 296/146.7

(57) ABSTRACT

A door trim includes a door pocket for containing a contained object. The door pocket is arranged to face a vehicle compartment and is formed between a trim main body having a port of taking in and out the contained object, and a box portion arranged on a vehicle exterior side of the trim main body. A vicinity of the access port of the box portion is provided with a rib structure member reinforced by a rib. A wall thickness of the trim main body is set to be smaller than a wall thickness of the box portion. The box portion includes a main body wall portion arranged at a portion remote from the trim main body to a vehicle exterior side, and a pair of end wall portions extended to a vicinity of the trim main body from end edges thereof opposed to each other in a front and rear direction by interposing the access port in the main body wall portion, and the rib structure member is hung between the two end wall portions.

### BACKGROUND OF THE INVENTION

1. Field of the Invention

The present invention relates to a door trim provided as an inner lining of a door of a vehicle, further in details, relates to a door trim having a door pocket for containing a contained object of an equipment article, a small article or the like.

2. Related Art

A main current is constituted by a door trim of a vehicle provided with a door pocket for containing a contained object of an equipment article, a small article or the like in order to promote an availability of a passenger (refer to JP-A-2007-314073, JP-A-2004-33857, JP-A-11-42992 and JP-UM-A-5-511). The door pocket is arranged to face a vehicle compartment, and is formed between a trim main body having a port of taking in and out a contained object, and a box portion arranged on a vehicle exterior side of the trim main body. Further, the box portion is locked by the trim main body from the vehicle exterior side by claw fitting or the like.

Meanwhile, in recent years, light-weighted formation of respective portions is requested for light-weighted formation of a total of a vehicle, and it is investigated to reduce a wall thickness of a portion of a door trim a wall thickness of which can be reduced, for example, a trim main body (thin wall formation). However, when the wall thickness of the trim main body is reduced, whereas a weight thereof is reduced, a rigidity thereof is reduced. As a result, when a force is exerted to the trim main body by being touched by a passenger or the like, there is a concern of easily bending the trim main body. With regard thereto, it is conceivable to reinforce the trim main body by providing a rib at a face on a vehicle exterior side of the trim main body (back face)(refer to JP-A-11-429925), however, when the rib is going to be integrally molded with the trim main body having a small wall thickness, ‘sink mark’ is brought about at a face (surface) on a vehicle compartment side of the trim main body owing to a shrinkage of the rib after having been molded, and there is a concern of deteriorating an outlook. Therefore, such a measure of providing the rib to the trim main body itself is not effective.

### SUMMARY OF THE INVENTION

The invention has been carried out in view of such an actual situation and it is an object there of to provide a door trim capable of compensating for a rigidity of a trim main body without bringing about a deterioration in an outlook at a surface of the trim main body.

In order to achieve the above-described object, a first aspect of the invention constitutes a door trim forming a part on a side of a vehicle compartment of a door of a vehicle and provided with a door pocket for containing a contained object, wherein the door pocket is arranged to face the vehicle compartment and is formed between a trim main body having a port of taking in and out the contained object, and a box portion arranged on a vehicle exterior side of the trim main body, and wherein a rib structure member reinforced by a rib is provided at at least a vicinity of the access port of the box portion.

According to the above-described constitution, the rib structure member itself reinforced by the rib is provided with a high rigidity. Further, by providing the rib structure member to the box portion, the rigidity of at least a vicinity of the rib structure member of the box portion is increased. Further, in the trim main body, a rigidity thereof at least at a portion at a vicinity of the rib structure member is compensated for by the rib structure member having the high rigidity as described above.

Particularly, it is conceivable that the rigidity of the trim main body is lower at a portion thereof at the vicinity of the access port than other portion. In this respect, according to the first aspect of the invention, the rib structure member is provided at least at the portion at the vicinity of the access port at the box portion, and therefore, the rigidity of at least the portion at the vicinity of the access port of the trim main body is compensated for by the rib structure member. Further, the rib is not provided to the trim main body, and therefore, a problem of the sink mark which can be brought about when the rib is integrally molded to the trim main body is not posed and a deterioration in an outlook of the surface of the trim main body by the sink mark in accordance therewith is not brought about.

Further, whereas the rigidity is increased by adding the rib structure member, a weight of a total of the door trim is increased. Therefore, from a view point of reducing an increase in the weight in accordance with addition of the rib structure member, it is preferable to make the rib structure member stay to a necessary minimum size. When the rib structure member is provided only at the vicinity of the access port of the box portion, the rigidity of the trim main body can be promoted while restraining the increase in the weight.

A second aspect of the invention constitutes the gist thereof by that a wall thickness of the trim main body is set to be smaller than a wall thickness of the box portion.

According to the above-described constitution, in the door trim in which the trim main body formed by the shape of more thin-walled than the box portion, the effect of the first aspect of the invention is achieved. That is, the rigidity of the trim main body reduced in accordance with the thin-walled formation can be compensated for by the rib structure member without bringing about the deterioration in the outlook of the surface of the trim main body while achieving light-weighted formation of the door trim more than the door trim in which the wall thickness of the trim main body is set to the degree the same as that of the wall thickness of the box portion.

A third aspect of the invention constitutes the gist by that the box portion includes a main body wall portion arranged at a portion remote from the trim main body to the vehicle exterior side, a pair of end wall portions extended to a vicinity of the trim main body from end edges of the main body wall portion opposed to each other by interposing the access port, and the rib structure member is hung between the two end wall portion of the box portion.

When the box portion having the stricture according to the third aspect of the invention is used, the box portion constitutes a mode of bridging the pair of end wall portions opposed to each other by interposing the access port by the rib structure member. According to the box portion, a moment of inertia of area constituting an index representing a difficulty of deforming an object is increased more than when the rib structure member is not provided. Therefore, the box portion is made to be difficult to deform.

A fourth aspect of the invention constitutes the gist by that the rib structure member includes a cover portion covering the rib at least from the vehicle exterior side.

According to the above-described constitution, when the passenger moves the hand at the vicinity of the access port at inside of the door pocket for containing the contained object to the door pocket, or taking out the contained object from the door pocket, the hand is restricted from touching the rib by the cover portion. The passenger does not directly touch the rib even when the hand is touched to the cover portion. Therefore, the passenger can feel a touch feeling different from that in directly touching the rib by the hand. Therefore, promotion of the touch feeling can be achieved by constituting, for example, at least the face on the vehicle exterior side of the cover portion by a face which is not projected and recessed of a flat face, a bent curved face or the like.

A fifth aspect of the invention constitutes the gist by that the cover portion is constituted by an elongated shape and is hung between the two end wall portions of the box portion.

According to the above-described constitution, the cover portion of connecting the two end wall portions formed between the two end wall portions of the box portion also achieves a function of not only covering the rib at least from the vehicle exterior side but increasing the moment of inertia of area of the box portion.

A sixth aspect of the invention constitutes the gist by that the rib structure member includes a frame member hung between the two end wall portions of the box portion and the rib is connected to the frame member.

By adopting the constitution of providing the rib at the frame member formed between the two end wall portions of the box portion, the rib structure member can be made to be light-weighted and highly rigid.

According to the door trim of the invention, the rib structure member reinforced by the rib is provided at at least the vicinity of the access port of the box portion, and therefore, the rigidity of the trim main body can be compensated for without bringing about the deterioration in the outlook of the surface of the trim main body.

### BRIEF DESCRIPTION OF THE DRAWINGS

FIG. 1 is a view showing an embodiment specifying the invention and is a partial perspective view viewing a door trim of a side door in an opened state from a vehicle rear side.

FIG. 2 is a perspective view of a state of viewing of a box portion and a rib structure member from a vehicle compartment side and a vehicle rear side.

FIG. 3 is a side view showing a state of viewing the box portion and the rib structure member from the vehicle compartment side.

FIG. 4 is a plane view of the box portion and the rib structure member.

FIG. 5 is an enlarged sectional view showing a sectional structure taken along a line X-X of FIG. 3.

FIG. 6 is a sectional view showing a sectional structure taken along a line Y-Y of FIG. 3.

FIG. 7 is an enlarged sectional view showing a sectional structure taken along a line Z-Z of FIG. 3.

FIG. 8 is a partially broken perspective view showing other example of the rib structure member.

### DETAILED DESCRIPTION OF THE PREFERRED EMBODIMENTS

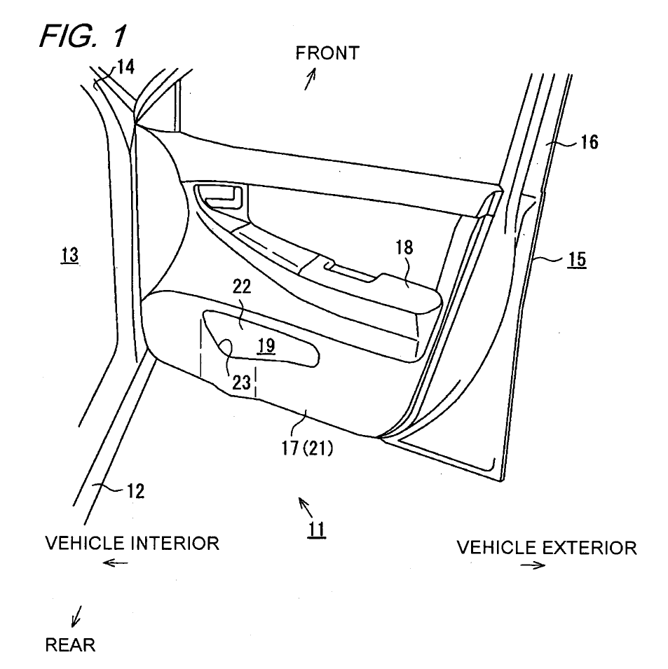

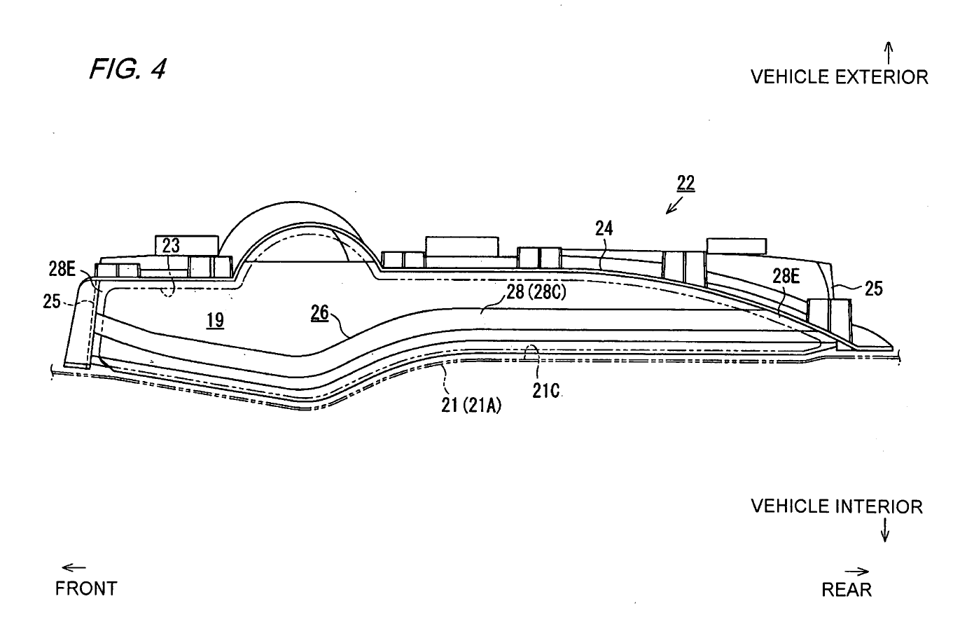

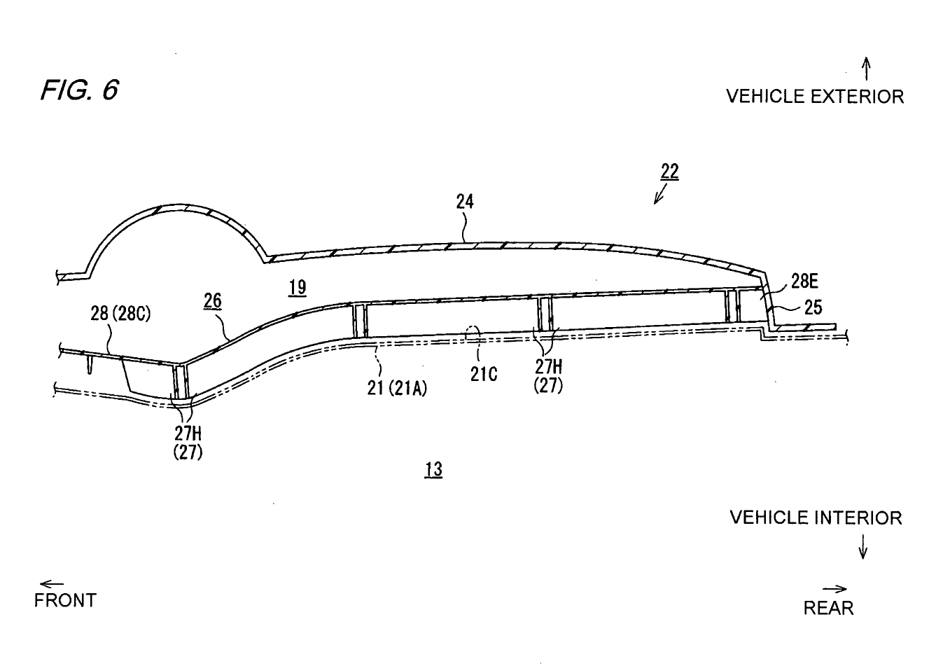

An embodiment specifying invention will be explained in reference to FIG. 1 through FIG. 7 as follows.

As shown by FIG. 1, in a body 12 of a vehicle 11, a riding port 14 of a passenger is provided at an outer side vicinity of a vehicle compartment 13. The body 12 is attached with a front door 15 for opening and closing the riding port 14 by being pivoted by constituting a fulcrum by a door hinge (not illustrated). The front door 15 corresponds to ‘door’ of the scope of claims. A portion of the front door 15 constituting a lower side of a window frame portion 16 and a side of the vehicle compartment 13 is constituted by a door trim 17. A middle portion in a height direction of the door trim 17 is provided with an arm rest portion 18. In the door trim 17, a lower side of the arm rest portion 18 is provided with a door pocket 19 for containing contained objects of small articles, a vehicle equipment article or the like.

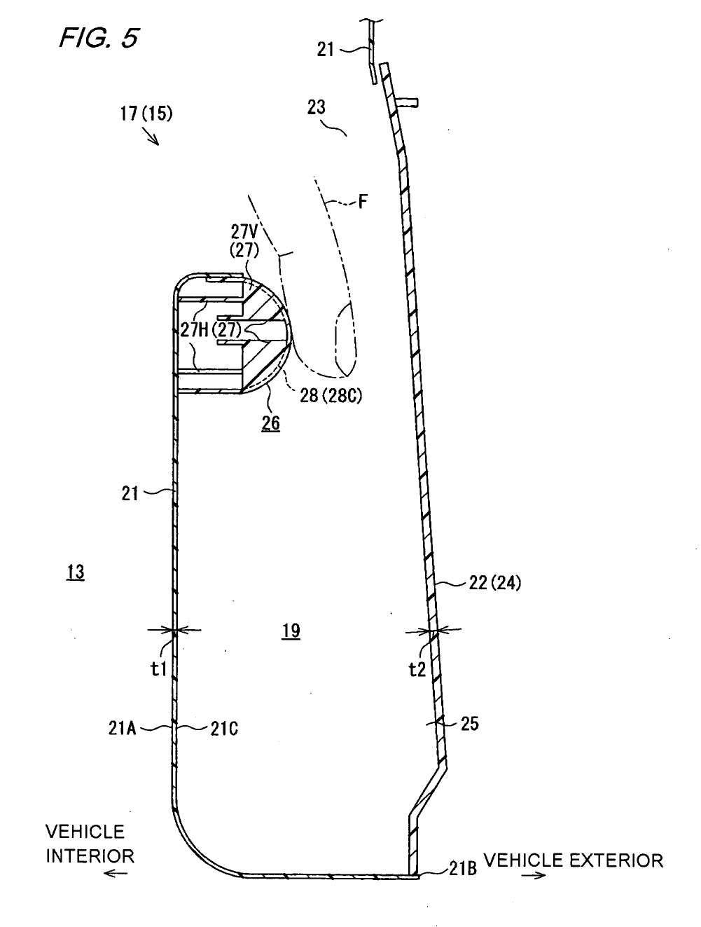

At a vicinity of the door pocket 19, the door trim 17 is constituted by a trim main body 21 and a box portion 22. As shown by at least one of FIG. 1 and FIG. 5, the trim main body 21 is arranged to face the vehicle compartment 13 and includes a port 23 of taking in and out the contained object. A lower end portion of the trim main body 21 is provided with a receiving portion 21B bent to the vehicle exterior side.

The trim main body 21 is formed by a resin material excellent in an impact resistant absorbing performance. Specifically, as a material physical property, a bending modulus of elasticity at 23° C. is preferably 2800 through 3100 MPa, a measured value by Izot test at 23° C. is preferably 150 through 260 J/m, a melt mass flow rate (MFR) at 230° C. is preferably 30 through 60 (further preferably, 40 through 50) g/10 min. As a material for realizing the material physical property, for example, a material whose major component is block polypropylene (block PP) added with rubber (SEBS, EP, EOM) and talc by a pertinent weight % is preferable. Examples of the blend materials and blend rates thereof are respectively shown in Table 1 and Table 2. Here, as talc, a mixture of talc having a mean particle size of 0.7 μm and talc having mean particle size of 4.4 μm is adopted.

TABLE 1

| blend material | blend rate (weight %) |
|---|---|
| block PP (MFR100) | 35 through 60 |
| SEBS | 8 through 20 |
| EP | |
| EOM | |
| talc (means particle size 0.7 μm + | 23 through 37 |
| means particle size 4.4 μm | |

TABLE 2

| blend material | blend rate (weight %) |
|---|---|
| block PP (MFR100) | 30 through 55 |
| homo PP | 5 through 25 |
| SEBS | 8 through 20 |
| EP | |
| EOM | |
| talc (means particle size 0.7 μm + | 23 through 37 |
| means particle size 4.4 μm | |

Although a wall thickness t1 of the trim main body 21 is normally set to be equal to or larger than 1 mm (for example, 2.2 through 2.5 mm), according to the embodiment, the wall thickness t1 is set to about 1 mm. A face (surface 21A) on a side of the vehicle compartment 13 of the trim main body 21 is decorated by pasting a skin member of cloth, resin sheet or the like thereto.

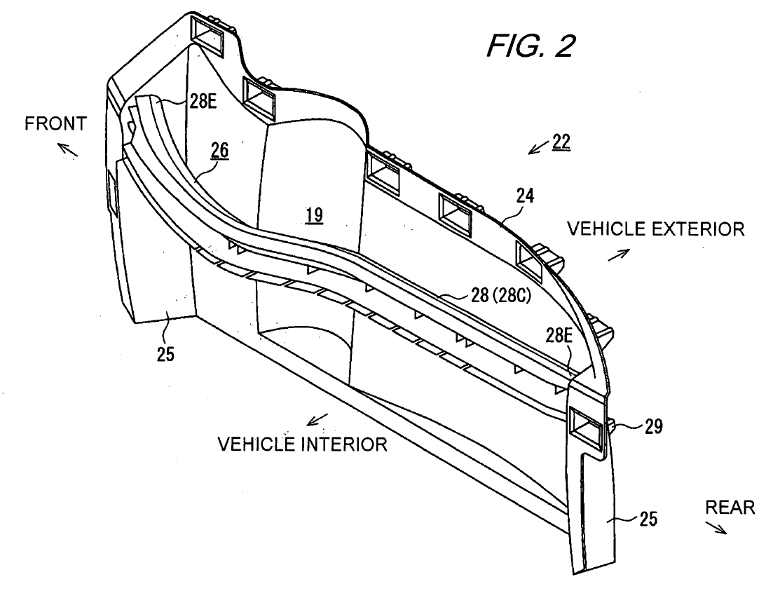

On the other hand, as shown by at least one of FIG. 2 through FIG. 4, the box portion 22 includes a main body wall portion 24 and a pair of front and rear end wall portions 25. The main body wall portion 24 is arranged at a portion of being remote from the trim main body 21 to the vehicle exterior side. The respective end wall portions 25 are extended to a side of the vehicle compartment 13 from end edges of the main body wall portion 24 opposed to each other in a front and rear direction by interposing the access port 23, and reach vicinities of the trim main body 21. A wall thickness t2 of respective portions of the box portion 22 is set to about 2.5 through 3.0 mm which is a value larger than wall thickness t1 of the trim main body 21.

The box portion 22 is locked by the trim main body 21 from the vehicle exterior side by means of claw fitting or the like at locking portions 29 or the like provided at the two front and rear end wall portions 25 or the like. In a state of attaching the box portion 22 to the trim main body 21 by the locking, a space an upper side of which is opened is formed by the both members 22, 21. The space corresponds to the door pocket 19 mentioned above and the opening corresponds to the access port 23. Further, the bottom portion of the door pocket 19 is constituted by the receiving portion 21B (refer to FIG. 5) of the trim main body 21.

The door trim 17 is provided with the above-described basic structure, and therefore, whereas a light weight can be achieved, a rigidity of the trim main body 21 becomes lower than a rigidity of the box portion 22. Above all, a rigidity of a portion of a vicinity of the access port 23 becomes low. Therefore, including a case of containing the contained object to the door pocket 19 and taking out the contained object from the door pocket 19, when a force of pushing to the vehicle exterior side is exerted particularly to the portion at the vicinity of the access port 23, there is a concern that the trim main body 21 is easily bent to the vehicle exterior side.

However, when a measure of adding a rib to a face (back face 21C) on the vehicle exterior side of the trim main body 21 is taken, as previously described, a recess referred to as ‘sink mark’ is brought about at a face (surface 21A) on a side of the vehicle compartment 13 of the trim main body 21 owing to the shrinkage of the rib after integrally molding the rib to the trim main body 21 having the small wall thickness t1, and there is a concern of deteriorating an outlook.

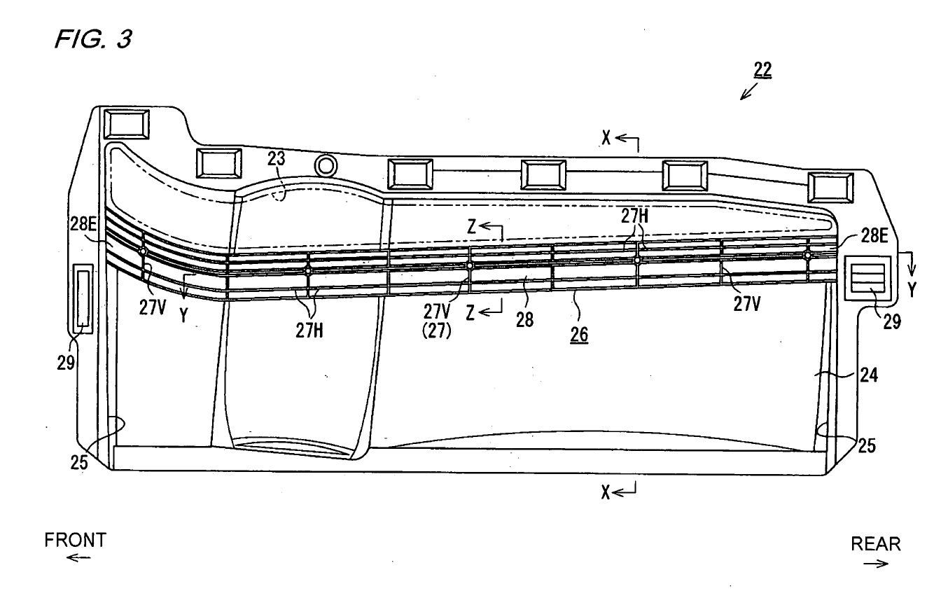

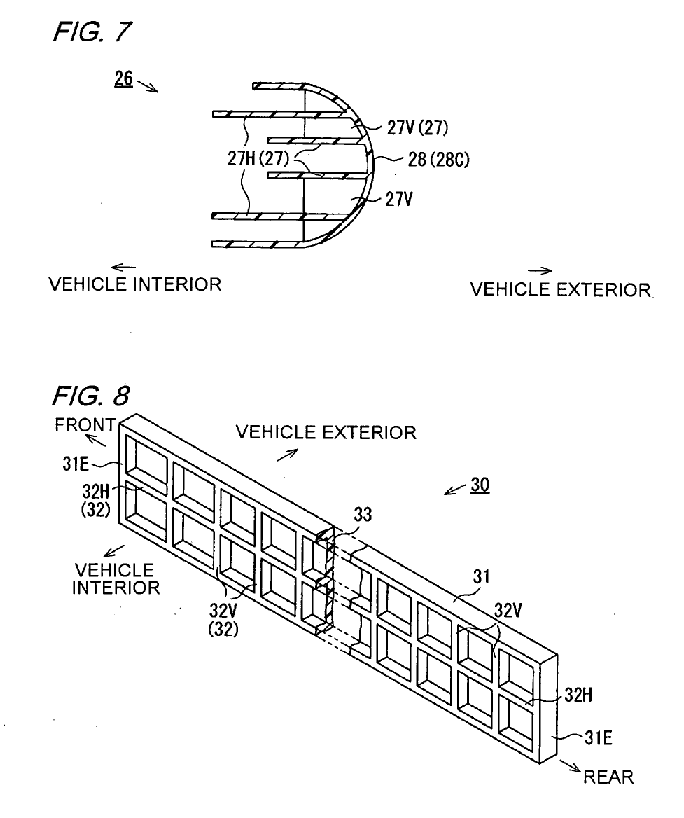

Hence, according to the embodiment, the concern is resolved by providing a structure member (hereinafter, referred to as ‘rib structure member 26’) reinforced by a rib 27 at a vicinity of the access port 23 of the box portion 22. As shown by FIG. 3, FIG. 5 though FIG. 7, the rib structure member 26 includes a single or a plurality of horizontal ribs 27H extended substantially in the horizontal direction at at least one portion, preferably at a plurality of portions substantially in a vertical direction, and a single or a plurality of vertical ribs 27V extended substantially in the vertical direction at at least one portion, preferably, at a plurality of portions substantially in the horizontal direction as the rib 27.

Further, the rib structure member 26 includes a cover portion 28 in an elongated shape extended in the front and rear direction of the vehicle 11 for covering all of the horizontal ribs 27H and all of the vertical ribs 27V from the vehicle exterior side, the upper side and the lower side. Other surface of the cover portion 28 excluding the face on the side of the vehicle compartment 13 constitutes a curved face 28C projected to the vehicle exterior side the most at a center portion in a height direction at any position in the front and rear direction of the vehicle 11.

The cover portion 28 is provided with a length to a degree the same as that of the main body wall portion 24 with regard to the front and rear direction of the vehicle 11. The rib structure member 26 is connected to upper end portions and end portion on sides of the vehicle compartment 13 of the two front and rear end wall portions 25 at two front and rear end portions of the horizontal ribs 27H and two front and rear end portions 28E of the cover portion 28. Here, the rib structure member 26 is connected thereto by forming the rib structure member 26 integrally with the box portion 22. In this way, in a state of hanging the rib structure member 26 between the two front and rear end wall portions 25 of the box portion 22, the rib structure member 26 is only brought into contact with or connected to the face (back face 21C) on the vehicle exterior side of the trim main body 21 and is not bonded thereto by adherence or the like.

According to the door trim 17 of the embodiment constituted as described above, the wall thickness t1 of the trim main body 21 is set to substantially 1 mm, and therefore, in comparison with a general door trim the wall thickness t1 of which is set to be equal to or larger than 2 mm (for example, 2.2 through 2.5 mm), a total of the door trim 17 is considerably lightened.

Further, according to the door trim 17 of the embodiment, the trim main body 21 itself is not provided with the rib, and therefore, there is not posed the problem of the sink mark which can be brought about when the rib is integrally molded to the trim main body 21 itself having the small wall thickness t1, and in accordance therewith, a deterioration in an outlook of a face (surface 21A) on the side of the vehicle compartment 13 of the trim main body 21 by the sink mark is not brought about. Further, the rib structure member 26 integrally formed with the rib 27 is provided with the wall thickness t2 twice as much as the wall thickness of the trim main body 21, and therefore, the sink mark is difficult to be produced. Further, even when the sink mark is assumedly produced at the cover portion 28, the sink mark is difficult to be optically recognized from the side of the vehicle compartment 13 since the cover portion 28 is disposed at inside of the box portion 22.

Further, according to the door trim 17, the rib structure member 26 itself reinforced by the rib 27 is provided with a high rigidity. Further, by providing the rib structure member 26 at the box portion 22, a rigidity of at least a portion at a vicinity of the rib structure member 26 of the box portion 22 is promoted. Particularly, according to the embodiment in which the box portion 22 includes the main body wall portion 24 and the pair of front and rear end wall portions 25, the rib structure member 26 is hung between the two end wall portions 25, and therefore, there is constituted a mode in which the box portion 22 bridges the pair of end wall portions 25 separated from each other by the rib structure member 26. In the box portion 22, a moment of inertia of area constituting an index representing a difficulty of deforming a body (bending rigidity: a resistance against bending) is increased more than that in a case of not providing the rib structure member 26. Therefore, the box portion 22 is difficult to be deformed when the contained object is contained in the door pocket 19 or the like.

Further, in the trim main body 21, at least a rigidity of a portion at a vicinity of the rib structure member 26, further accurately, a bending rigidity against a force directed to the vehicle exterior side is compensated for by the rib structure member 26 having the high rigidity.

Particularly, the rigidity of the trim main body 21 itself is low at a portion at a vicinity of the access port 23 more than other portion. In this respect, according to the embodiment, the rib structure member 26 is provided at the portion at the vicinity of the access port 23 of the box portion 22, and therefore, at least a rigidity of the portion at the vicinity of the access port 23 of the trim main body 21 is compensated for by the rib structure member 26.

The cover portion 28 of connecting the two end wall portions 25 by being hung between the two end wall portions 25 of the box portion 22 not only covers the rib 27 but achieves also a function of promoting at least the rigidity of the portion at the vicinity of the access port 23 of the trim main body 21 by increasing the moment of inertia of area of the box portion 22.

Further, whereas when the rib structure member 26 is added, the rigidity is increased, the weight of the total of the door trim 17 is increased. Therefore, from a view point of reducing the increase in the weight in accordance with addition of the rib structure member 26, it is preferable to make a size of the rib structure member 26 stay in a necessary minimum size. In this respect, according to the embodiment, the rib structure member 26 is provided only at the vicinity of the access port 23 of the box portion 22, and therefore, the increase in the weight in accordance with addition of the rib structure member 26 is made to be comparatively small while increasing the rigidity of the trim main body 21.

Further, when a large force (impact) directed to the vehicle exterior side is exerted instantaneously to the trim main body 21 from the side of the vehicle compartment 13, the impact is transmitted to the box portion 22 by the rib structure member 26 by way of the ribs 27 (horizontal rib 27H, vertical rib 27V) and the cover portion 28. In a procedure of the transmission, at least a portion of the impact is absorbed by bending the ribs 27 (horizontal rib 27H, vertical rib 27V).

Meanwhile, there is a case in which when the passenger moves the hand at inside of the door pocket 19 in order to contain the contained object to the door pocket 19, or take out the contained object from the door pocket 19, the hand is touched to the portion constituting the door pocket 19 in the trim main body 21 and the box portion 22. An object of contact is also constituted by the rib structure member 26 added to the prior art structure. Further in details, a portion of the object of the contact of the hand is constituted by surfaces (face of vehicle exterior side, upper face, and lower face) other than the face on the side of the vehicle compartment 13 at which the trim main body 21 is disposed in the surfaces of the rib structure member 26. At this occasion, when the rib is assumedly exposed at inside of the door pocket 19, the hand moved at inside of the door pocket 19 touches the rib 27 from any of the upper side, the vehicle exterior side and the lower side. The horizontal rib 27H and the vertical rib 27V constitute the plate-like shape, surroundings thereof are constituted by spaces, and therefore, when the hand is touched to the horizontal rib 27H and the vertical rib 27V, the passenger feels a feeling of projections and recesses.

In this respect, according to the embodiment in which the rib 27 is covered from the vehicle exterior side, the upper side and the lower side by the cover portion 28, as shown by a two-dotted chain line of FIG. 5, it is restricted by the cover portion 28 that the hand moved at inside of the door pocket 19, for example, the finger F touches the rib 27 from the vehicle exterior side, the upper side and the lower side. Even when the passenger moves the finger F in any direction, although the finger F may touch the cover portion 28, the finger F does not directly touch the rib 27. Therefore, the passenger feels a touch feeling different from that when the passenger directly touches the rib 27.

According to the embodiment, even when the other surface of the cover portion 28 excluding the face on the side of the vehicle compartment 13 constitutes the bent face 28C projected to the vehicle exterior side the most in the center portion in the height direction at any position in the front and rear direction of the vehicle. Therefore, the passenger touches the smooth face of the bent face 28C of the cover portion 28. Further, even when the hand (the finger F) is moved in any direction at inside of the door pocket 19, the hand touches the bent face 28C.

According to the embodiment described above in details, the following effect is achieved.

(1) The vicinity of the access port 23 of the box portion 22 is provided with the rib structure member 26 reinforced by the ribs (horizontal rib 27H, vertical rib 27V). Therefore, the rigidity of at least the portion of the vicinity of the access port 23 of the trim main body 21 can be increased and the trim main body 21 is restrained from being bent to the vehicle exterior side while avoiding the deterioration in the outlook of the surface 21A of the trim main body 21 by the sink mark.

(2) The wall thickness t1 of the trim main body 21 is set to be smaller than the wall thickness t2 of the box portion 22. Therefore, in comparison with the door trim of the background art in which the trim main body 21 is set to a degree the same as that of the box portion 22, according to the embodiment, the door trim 17 can be made to be light-weighted. In accordance therewith, light-weighted formation of the total of the vehicle is achieved, which can contribute to promotion of the fuel cost thereby.

(3) The rib structure member 26 is provided only at the vicinity of the access port 23 of the box portion 22. Therefore, the increase in the weight in accordance with addition of the rib structure member 26 can be reduced.

(4) The box portions 22 having the main body wall portions 24 and the pair of end wall portions 25 opposed to each other in the front rear direction by interposing the access port 23 are used and the rib structure member 26 is hung between the two end wall portions 25. Therefore, deformation of the box portion 22 can be restrained by increasing the moment of inertia of area of the box portion 22.

(5) The rib structure member 26 is provided with the cover portion 28 of covering the ribs 27 (horizontal rib 27H, vertical rib 27V) from the vehicle exterior side, the upper side and the lower side. Therefore, promotion of a touch feeling when touching the hand (finger F) can be achieved more than in a case of exposing the rib 27 without providing the cover portion 28.

(6) The cover portion 28 is constituted by the elongated shape, and hung between the two end wall portions 25 of the box portion 22. Therefore, the rigidity of at least the portion at the vicinity of the access port 23 of the trim main body 21 can be promoted.

Further, even when a large force (impact) directed to the vehicle exterior side is instantaneously exerted to the trim main body 21 from the side of the vehicle compartment 13, at least a portion of the impact can be absorbed by bending the ribs (horizontal rib 27H, vertical rib 27V).

(7) The material of molding the trim main body 21 particularly having the material physical property that the bending modulus of elasticity at 23° C. is 1800 through 3100 MPa, the measured value by the Izot test at 23° C. is 150 through 260 J/m is adopted. Therefore, the impact resistant absorbing performance of the trim main body 21 can be promoted.

(8) When the wall thickness t1 of the trim main body 21 is thinned to the degree of 1 mm as in the embodiment, in comparison with a case in which the wall thickness t1 is, for example, about 3 mm, a fluidity of the resin material in molding is deteriorated, and a problem of increasing a time period required for resin molding or increasing in a failure rate of a molded product is posed. In this respect, according to the embodiment, the material of molding the trim main body 21 particularly having the material physical property that the melt mass flow rate (MFR) at 230° C. is 40 through 50 g/10 min is adopted. Therefore, the increase in the fluidity of the resin material can be achieved, and even when a length of making the resin material flow is prolonged, or a flow area is increased, the increase in the time period required for resin molding can be restrained and the increase in the failure rate of the molded product can be restrained.

(9) As talk blended to the resin material, the mixture of talc having the mean particle size of 0.7 μm and talc having the mean particle size of 4.4 μm is adopted. Therefore, both of the bending modulus of elasticity and the measured value by the Izot test can be increased. Further, the mixture talc is constituted by talc having the mean particle size of 0.7 μm which considerably contributes to the material physical property and talc having the mean particle size of 4.4 μm which is generally more inexpensive than talc having the mean particle size of 0.7 μm, and therefore, while realizing the material physical property, the cost can be restrained to be low.

Further, the invention can be specified to other embodiment shown below.

<Item With Regard to Box Portion 22>

The box portion 22 may be locked by the trim main body 21 by locking means different from claw fitting.

At the box portion 22, the wall thickness t2 at least at the portion at the vicinity of the rib structure member 26 may be set to be smaller than that of the embodiment, for example, to a degree the same as the wall thickness t1 of the trim main body 21.

<Item With Regard to Rib Structure Member>

The cover portion 28 may be constituted to cover the rib 27 at least from the vehicle exterior side. Therefore, the cover portion 28 may be constituted to cover the rib 27 only from the vehicle exterior side, may be constituted to cover the rib 27 from the vehicle exterior side and the upper side, or to cover the rib 27 from the vehicle exterior side and the lower side.

The rib structure member may be constituted to be reinforced by the rib, and may be constituted to include a constitution different from that of the embodiment.

An example thereof is shown in FIG. 8. The rib structure member 30 is constituted by including a frame member 31 and a rib 32. The frame member 31 constitutes a shape of a quadrangular ring extended in the vehicle front and rear direction, and is fixed to the end wall portion 25 of the box portion 22 at both end portions 31E in the direction. The rib 32 is constituted by a horizontal rib 32H, a vertical rib 32V and constitutes a shape of a lattice. Further, the horizontal rib 32H and vertical rib 32V are integrally formed with the frame member 31 at outer edge portions thereof. By adopting such a constitution, the rib structure member 26 can be made to be light-weighted and highly rigid.

Further, even when the frame member 31 is used as described above, a cover portion 33 of covering the rib 32 may be provided on the vehicle exterior side of the frame member 31.

The rib 27 according to the embodiment may be constituted only by the horizontal rib 27H, further, may be constituted only by the vertical rib 27V. Similarly, the rib 32 in FIG. 8 may be constituted only by the horizontal rib 32H, further, may be constituted only by the vertical rib 32V.

So far as the increase in the weight in accordance with addition of the rib structure member 26 is confined in an allowable range, the rib structure member 26 may be provided at a lower portion of the access port 23 in addition to the vicinity of the access port 23. Further, in that case, a further considerable effect is achieved in that the rigidity of the trim main body 21 is compensated for by the rib structure member 26.

The rib structure members 26, 30 may be bonded to the back face 21C of the trim main body 21 by means of adhering, welding or the like. Thereby, even when a force directed to the side of the vehicle compartment 13 may be exerted to the trim main body 21, the trim main body 21 can be made to be difficult to deform in the same direction. In this case, the rib structure member 26 and the trim main body 21 may be bonded at at least a necessary portion.

The rib structure members 26, 30 may be formed separately from the box portion 22, thereafter, the same rib structure members 26, 30 may be changed to a constitution of being mounted to the box portion 22.

There may be constructed a constitution in which the rib 27 and the cover portion 28 of the rib structure member 26 may be formed separately from each other, thereafter, the cover portion 28 is mounted to the rib 27.

<With Regard to Application Range>

The invention is applicable to a door trim of not only the front door but other door of the vehicle, for example, a rear door or a back door.

What is claimed is:

1. A door trim forming a part on a side of a vehicle compartment of a door of a vehicle and provided with a door pocket for containing a contained object;
wherein the door pocket is arranged to face the vehicle compartment and is formed between a trim main body having an access port of taking in and out the contained object, and a box portion arranged on a vehicle exterior side of the trim main body; and
wherein a rib structure member reinforced by a rib is provided at at least a vicinity of the access port of the box portion.

2. The door trim according to claim 1, wherein a wall thickness of the trim main body is set to be smaller than a wall thickness of the box portion.

3. The door trim according to claim 1, wherein the box portion includes a main body wall portion arranged at a portion remote from the trim main body to the vehicle exterior side, a pair of end wall portions extended to a vicinity of the trim main body from end edges of the main body wall portion opposed to each other by interposing the access port; and
wherein the rib structure member is hung between the two end wall portions of the box portion.

4. The door trim according to claim 3, wherein the rib structure member includes a cover portion covering the rib at least from the vehicle exterior side.

5. The door trim according to claim 4, wherein the cover portion is constituted by an elongated shape and is hung between the two end wall portions of the box portion.

6. The door trim according to claim 3, wherein the rib structure member includes a frame member hung between the two end wall portions of the box portion and the rib is connected to the frame member.
